(19) United States
(12) Patent Application Publication
(10) Pub. No.: US 2015/0355569 A1
(43) Pub. Date: Dec. 10, 2015

(54) ROTATIONAL POSITION DETECTION DEVICE, IMAGE FORMING APPARATUS, AND NON-TRANSITORY COMPUTER READABLE MEDIUM STORING ROTATIONAL POSITION DETECTION PROGRAM

(71) Applicant: FUJI XEROX CO., LTD., Tokyo (JP)

(72) Inventors: Fumiya HISA, Kanagawa (JP); Yuma MOTEGI, Kanagawa (JP)

(73) Assignee: FUJI XEROX CO., LTD., Tokyo (JP)

(21) Appl. No.: 14/564,246

(22) Filed: Dec. 9, 2014

(30) Foreign Application Priority Data
Jun. 4, 2014 (JP) 2014-115923

(51) Int. Cl. G03G 15/08; G03G 15/00

(52) U.S. Cl. CPC G03G 15/0808; G03G 15/50

(57) ABSTRACT

Provided is a rotational position detection device including a position detection unit that is provided in a motor for driving a developing roll developing a latent image, detects a rotational position of the motor by using magnetism, and outputs a rotational position signal for each rotational position determined in advance, and a generation unit that generates a reference signal indicating a reference position of rotation of the developing roll using the rotational position signal, based on a transmission ratio of a transmission mechanism that transmits driving of the motor to the developing roll.

### CROSS-REFERENCE TO RELATED APPLICATIONS

This application is based on and claims priority under 35 USC 119 from Japanese Patent Application No. 2014-115923 filed Jun. 4, 2014.

### BACKGROUND

### Technical Field

The present invention relates to a rotational position detection device, an image forming apparatus, and a non-transitory computer readable medium storing a rotational position detection program.

### SUMMARY

According to an aspect of the invention, there is provided a rotational position detection device including:

a position detection unit that is provided in a motor for driving a developing roll developing a latent image, detects a rotational position of the motor by using magnetism, and outputs a rotational position signal for each rotational position determined in advance; and

a generation unit that generates a reference signal indicating a reference position of rotation of the developing roll using the rotational position signal, based on a transmission ratio of a transmission mechanism that transmits driving of the motor to the developing roll.

### BRIEF DESCRIPTION OF THE DRAWINGS

Exemplary embodiments of the present invention will be described in detail based on the following figures, wherein:

FIG. 1 is a diagram showing a schematic configuration of an image processing apparatus according to an exemplary embodiment;

FIG. 2 is a diagram showing a schematic configuration of a portion of the drive systems of a photoreceptor drum and a developing roll of the image forming apparatus according to the exemplary embodiment;

FIG. 3 is a block diagram showing a schematic configuration of a control device of the image forming apparatus according to the exemplary embodiment;

FIG. 4A is a diagram showing an example of a detection result of a hall element with respect to a phase change of a motor in a case where a three-phase motor with twelve poles is applied, FIG. 4B is a diagram showing an example of the detection result of the hall element in the case of FIG. 4A being converted into a pulse signal, and FIG. 4C is a diagram illustrating the generation of a reference signal from the pulse signal of FIG. 4B;

FIG. 5A is a diagram showing an example of a detection result of a hall element with respect to a phase change of a motor in a case where a three-phase motor with eight poles is applied, FIG. 5B is a diagram showing an example of the detection result of the hall element in the case of FIG. 5A being converted into a pulse signal, and FIG. 5C is a diagram illustrating the generation of a reference signal from the pulse signal of FIG. 5B;

FIG. 6A is a diagram showing an example of a three-phase motor with two poles, and FIG. 6B is a diagram illustrating the generation of a reference signal from a pulse signal obtained by converting a detection result of a hall element when a transmission ratio is set to 1; and

FIG. 7 is a flow chart showing an example of a process performed by a controller of the image forming apparatus according to the exemplary embodiment.

### DETAILED DESCRIPTION

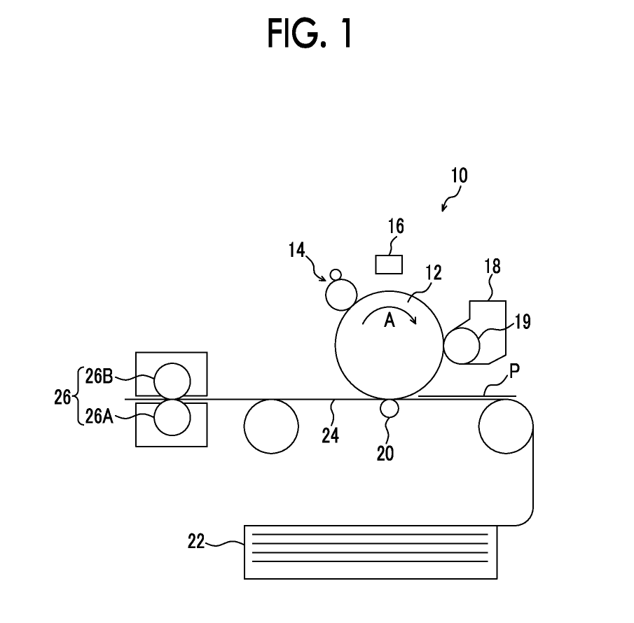

Hereinafter, the exemplary embodiment will be described with reference to the accompanying drawings. FIG. 1 is a diagram showing a schematic configuration of an image forming apparatus 10 according to the exemplary embodiment.

As shown in FIG. 1, the image forming apparatus 10 according to the exemplary embodiment includes a photoreceptor drum 12 that is rotated in the direction of an arrow A of FIG. 1. Meanwhile, the rotation direction (direction of the arrow A of FIG. 1) of the photoreceptor drum 12 corresponds to a sub-scanning direction, and an optical scanning direction based on an optical scanner 16 to be described later corresponds to a main scanning direction.

A charging device 14, the optical scanner 16, a developer 18, a transfer roller 20, a cleaner (not shown), and a charge eliminator (not shown) are disposed in order in the periphery of the photoreceptor drum 12 along the rotation direction of the photoreceptor drum 12.

That is, the surface of the photoreceptor drum 12 is charged by the charging device 14 and is then irradiated with a light beam by the optical scanner 16, and thus a latent image is formed on the photoreceptor drum 12. Meanwhile, the optical scanner 16 irradiates the photoreceptor drum 12 with a light beam which is modulated based on image data.

The latent image formed on the photoreceptor drum 12 is developed by a developing roll 19 of the developer 18 using a toner supplied thereto, and thus a toner image is formed on the photoreceptor drum 12. The toner image on the photoreceptor drum 12 is transferred to paper P by the transfer roller 20. The paper P is taken out one by one from a paper accommodation unit 22 and is transported up to the location of the transfer roller 20 by a paper transport belt 24.

A toner remaining in the photoreceptor drum 12 after the transfer of the toner image is removed by a cleaner (not shown), is electrostatically discharged by a charge eliminator (not shown), and is then charged again by the charging device 14, and thus the above-described operations are repeated.

On the other hand, the paper P having the toner image transferred thereto is transported to a fixing machine 26 including a pressure roller 26A and a heating roller 26B and is then subjected to a fixing process. Thus, the toner image is fixed, and thus a desired image is formed on the paper P. The paper P having the image formed thereon is discharged to the outside of the apparatus.

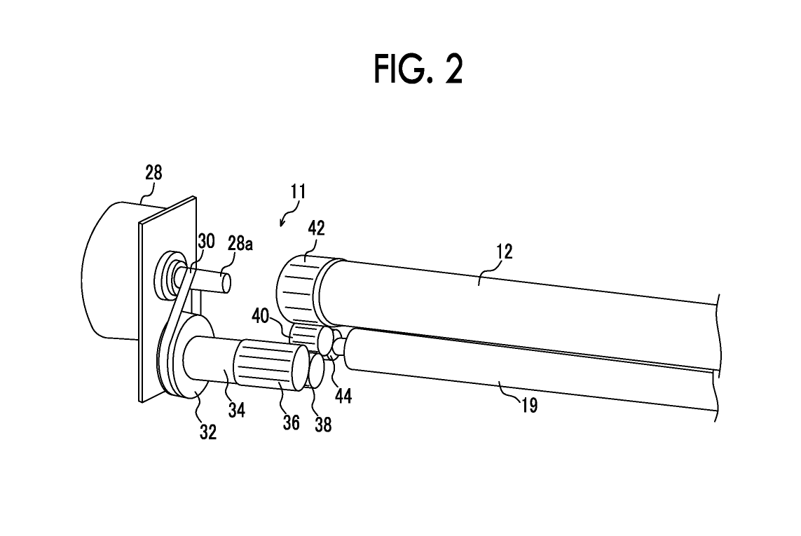

Hereinafter, drive systems of the photoreceptor drum 12 and the developing roll 19 will be described. FIG. 2 is a diagram showing a schematic configuration of a portion of the drive systems of the photoreceptor drum 12 and the developing roll 19 of the image forming apparatus 10 according to the exemplary embodiment.

The image forming apparatus 10 according to the exemplary embodiment includes a motor 28 for driving the photoreceptor drum 12 and the developing roll 19.

A driving force of the motor 28 is transmitted to the photoreceptor drum 12 and the developing roll 19 by a transmission mechanism 11. That is, the photoreceptor drum 12 and the developing roll 19 are rotated by the motor 28.

The transmission mechanism 11 is configured to include a belt 30, a pulley 32, a first to third gears 36 to 40, a photoreceptor gear 42, and a developing gear 44.

In detail, the belt 30 is wound around a rotary shaft 28a of the motor 28. In addition, the belt 30 is wound around the pulley 32.

A shaft 34 engages with a rotary shaft of the pulley 32, and the shaft 34 meshes with the first gear 36. The first gear 36 meshes with a second gear 38, and the second gear 38 meshes with the third gear 40.

In addition, the photoreceptor drum 12 is provided with the photoreceptor gear 42, and the developing roll 19 is provided with the developing gear 44.

The third gear 40 meshes with both the photoreceptor gear 42 and the developing gear 44. That is, the rotation of the motor 28 is transmitted to the photoreceptor gear 42 and the developing gear 44 through the belt 30, the pulley 32, and the first to third gears 36 to 40.

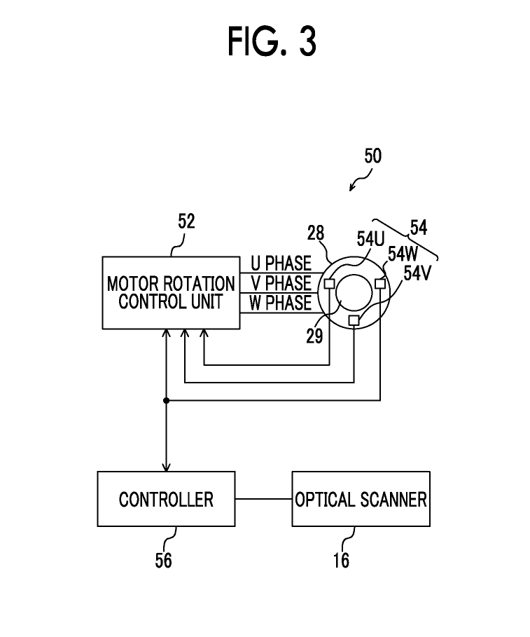

Subsequently, a schematic configuration of a control device of the image forming apparatus 10 according to the exemplary embodiment will be described. FIG. 3 is a block diagram showing a schematic configuration of a control device 50 of the image forming apparatus 10 according to the exemplary embodiment.

The control device 50 of the image forming apparatus 10 includes a motor rotation control unit 52 that controls the rotation of the motor 28. A three-phase motor is used as the motor 28 in the exemplary embodiment. The motor rotation control unit 52 controls the rotation of the motor by controlling electrification to a U phase, a V phase, and a W phase.

In addition, the motor 28 includes a magnetic detection unit that detects a rotational position of a rotating body (so-called rotor) 29 using magnetism in order to perform electrification to the U phase, the V phase, and the W phase. In the exemplary embodiment, as an example of the magnetic detection unit, three hall elements 54 (54U, 54V, and 54W) are provided.

The driving of the hall element 54 is controlled by the motor rotation control unit 52, and a detection result of the hall element 54 is input to the motor rotation control unit 52. That is, the motor rotation control unit 52 detects the rotational position of the rotating body 29 of the motor 28 based on the detection result of the hall element 54, and controls electrification to the U phase, the V phase, and the W phase in accordance with the detection result.

In the exemplary embodiment, a detection result of at least one hall element 54 (hall element 54V in FIG. 3) among the three hall elements 54 is also input to a controller 56 that controls the entire image forming apparatus 10.

The controller 56 has a reference signal generation function as a generation unit that generates a reference signal indicating a rotation reference position of the developing roll 19 by using the detection result of the hall element 54. In addition, the controller 56 has a correction function of correcting periodic image unevenness and the like by correcting the amount of light of the optical scanner 16 based on the reference signal generated by the reference signal generation function.

Hereinafter, a method of generating the reference signal, which is generated by the above-described reference signal generation function of the controller 56, will be described in detail.

A relationship between the number of rotations of the motor 28 and the number of rotations of the developing roll 19 is determined by a transmission ratio (so-called gear ratio) between the motor 28 and the developing gear 44, and thus the number of rotations of the motor 28 during one rotation of the developing roll 19 is determined from the transmission ratio.

Consequently, in the exemplary embodiment, the controller 56 generates a reference signal for each rotation of the developing roll 19 from the detection result of the hall element 54 based on the transmission ratio.

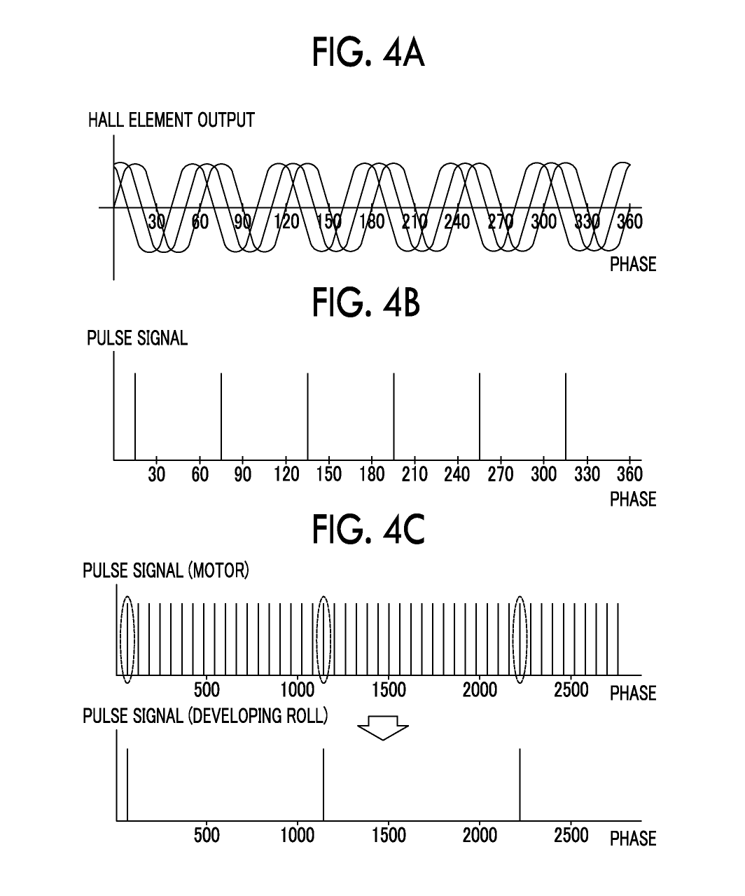

FIG. 4A is a diagram showing an example of the detection result of the hall element 54 with respect to a phase change of the motor 28 in a case where a three-phase motor with twelve poles is applied. FIG. 4B is a diagram showing an example of the detection result of the hall element 54 in the case of FIG. 4A being converted into a pulse signal. FIG. 4C is a diagram illustrating the generation of a reference signal from the pulse signal of FIG. 4B.

For example, when a three-phase motor with twelve poles is applied, the detection results of the three hall elements 54 become waveforms of which the phases are shifted by 10 degrees, as shown in FIG. 4A. When the waveforms are converted into pulse signals, the pulse signal is generated six times during one rotation (phase of 360 degrees) as shown in FIG. 4B.

On the other hand, a relationship between the number of rotations of the motor 28 and the number of rotations of the developing roll 19 is determined by a transmission ratio between the motor 28 and the developing gear 44, as described above. Here, when the number of rotations of the motor 28 is set to 1800 rpm and the number of rotations of the developing roll 19 is set to 600 rpm, the transmission ratio (the number of rotations of the motor 28 with respect to the number of rotations of the developing roll 19) is 3. Thus, when the rotating body 29 of the motor 28 is rotated three rotations, the developing roll 19 is rotated one rotation. In addition, since the motor 28 has twelve poles, a signal obtained by converting the detection result of the hall element 54 into a pulse signal is output six times during one rotation of the rotating body 29 of the motor 28 as described above.

Accordingly, as shown in FIG. 4C, a pulse signal spaced for every 6×3=18 pulses is generated as a reference signal, and thus a reference position of the developing roll 19 is detected from the detection result of the hall element 54.

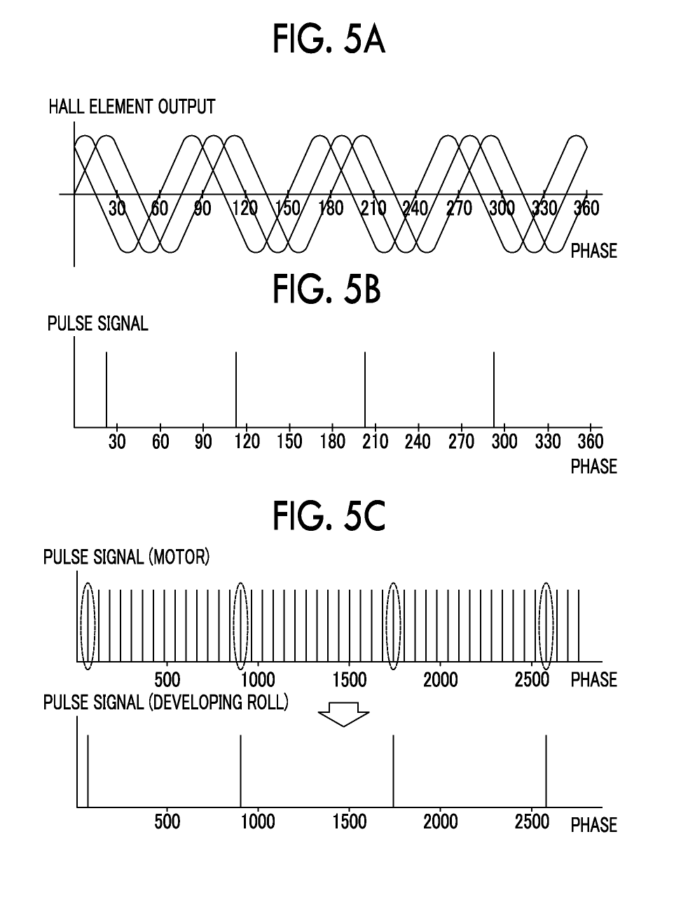

Next, a description will be made of a case where another three-phase motor having a different number of poles is applied. FIG. 5A is a diagram showing an example of a detection result of the hall element 54 with respect to a phase change of the motor 28 in a case where a three-phase motor with eight poles is applied. FIG. 5B is a diagram showing an example of the detection result of the hall element 54 in the case of FIG. 5A being converted into a pulse signal. FIG. 5C is a diagram illustrating the generation of a reference signal from the pulse signal of FIG. 5B.

When a three-phase motor with eight poles is applied, the detection results of the three hall elements 54 become waveforms of which the phases are shifted by 15 degrees, as shown in FIG. 5A. When the waveforms are converted into pulse signals, the pulse signal is generated four times during one rotation (phase of 360 degrees) as shown in FIG. 5B.

On the other hand, a relationship between the number of rotations of the motor 28 and the number of rotations of the developing roll 19 is determined by a transmission ratio between the motor 28 and the developing gear 44. Here, when the number of rotations of the motor 28 is set to 2100 rpm and the number of rotations of the developing roll 19 is set to 600 rpm, the transmission ratio (the number of rotations of the motor 28 with respect to the number of rotations of the developing roll 19) is 3.5. Thus, when the rotating body 29 of the motor 28 is rotated 3.5 rotations, the developing roll 19 is rotated one rotation. In addition, since the motor 28 has eight poles, a signal obtained by converting the detection result of the hall element 54 into a pulse signal is output four times during one rotation of the rotating body 29 of the motor 28, as described above.

Accordingly, as shown in FIG. 5C, a pulse signal spaced for every 3.5×4=14 pulses is generated as a reference signal, and thus the reference position of the developing roll 19 is detected from the detection result of the hall element 54.

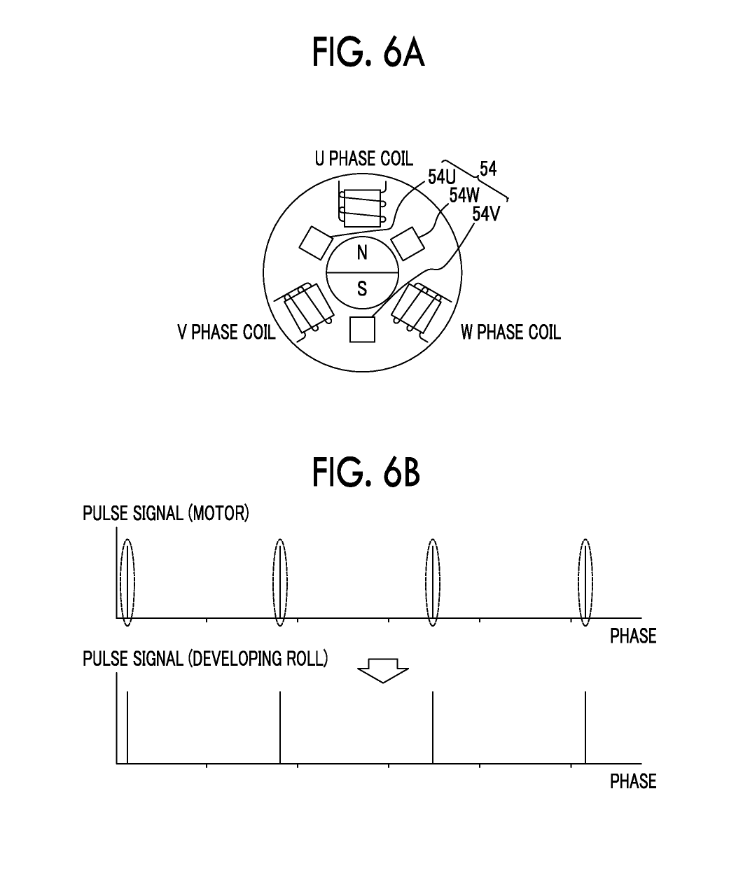

Meanwhile, a three-phase motor with two poles as shown in FIG. 6A is applied. When the number of rotations of the motor 28 is set to be the same as the number of rotations of the developing roll 19 (when a transmission ratio is set to 1), a pulse signal obtained from the detection result of the hall element 54 may be used as a reference signal of the developing roll 19. In this manner, since the pulse signal obtained from the detection result of the hall element 54 may be used as a reference signal, the generation of the reference signal is facilitated. Meanwhile, FIG. 6A is a diagram showing an example of a three-phase motor with two poles, and FIG. 6B is a diagram illustrating the generation of a reference signal from a pulse signal obtained by converting the detection result of a hall element when a transmission ratio is set to 1.

Hereinafter, a method of generating the above-described reference signal will be generalized and described. When a three-phase motor having 2×N poles (N is a natural number) is applied, a pulse signal obtained based on the output of the hall element 54 is generated for each rotational position, which is determined in advance, of the rotating body 29 of the motor 28. The pulse signal is generated N times during one rotation of the rotating body 29 of the motor 28.

In addition, a relationship between the number of rotations of the motor 28 and the number of rotations of the developing roll 19 is determined by a transmission ratio between the motor 28 and the developing gear 44. That is, when the transmission ratio (the number of rotations of the motor 28 with respect to the number of rotations of the developing roll 19) is A, the developing roll 19 is rotated one rotation while the rotating body 29 of the motor 28 is rotated A rotations. Accordingly, the controller 56 generates a pulse signal spaced for every A×N pulses as a reference position among the pulse signals obtained from the output of the hall element 54, and thus a reference position of the developing roll 19 may be detected from the detection result of the hall element 54. At this time, it is preferable that a speed-reduction ratio be set so that the number of rotations of the motor 28 is set to be natural number-time as large as the number of rotations of the developing roll 19. In addition, it is preferable that a transmission ratio be set so that a result of integration (A×N) of the number of pulse signals obtained during one rotation of the motor 28 and a value obtained by dividing the number of rotations of the motor 28 by the number of rotations of the developing roll is set to be the natural number.

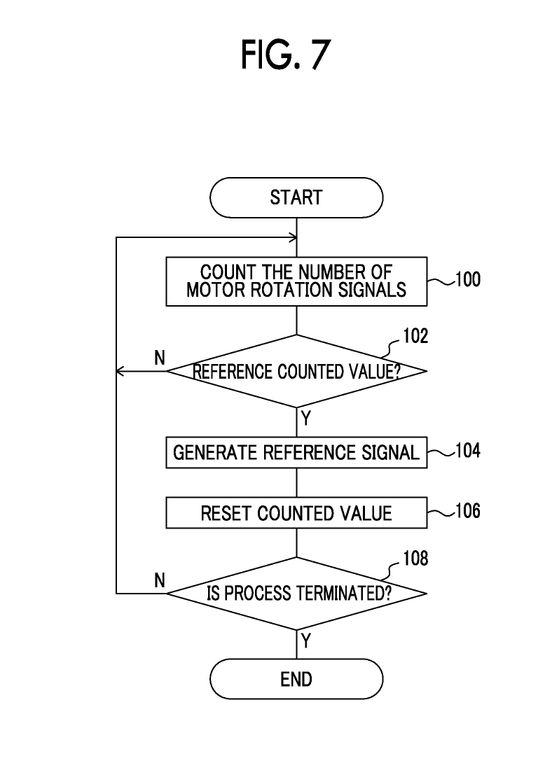

Subsequently, a description will be made of a specific example of a process performed by the controller 56 of the image forming apparatus 10 according to the exemplary embodiment which is configured in the above-described manner. FIG. 7 is a flow chart showing an example of a process performed by the controller 56 of the image forming apparatus 10 according to the exemplary embodiment.

First, in step 100, the controller 56 counts the number of motor rotation signals, and then proceeds to step 102. That is, the number of pulse signals obtained from the detection result of the hall element 54 is counted.

In step 102, the controller 56 determines whether or not the counted value is set to be a reference counted value which is determined in advance. In the determination, it is determined whether the above-described A×N pulses are counted. When the determination is negative, the process returns to step 100 to continue the counting of the pulse signals. When the determination is affirmative, the process proceeds to step 104.

In step 104, the controller 56 generates a reference signal, and then proceeds to step 106. That is, the controller 56 generates a pulse signal spaced for every A×N pulses as a reference signal.

In step 106, the controller 56 resets the counted value, and then proceeds to step 108.

In step 108, it is determined whether or not the process of the controller 56 is terminated. In the determination, for example, it is determined whether or not an image forming operation is terminated or whether or not the rotation of the motor 28 is stopped. When the determination is negative, the process returns to step 100 to repeat the above-described operations. When the determination is affirmative, a series of operations are terminated.

The controller 56 controls the optical scanner 16 by using the reference signal generated in this manner to thereby correct the amount of light, and thus periodic density unevenness of an image is corrected. Meanwhile, when the periodic unevenness is corrected, the periodic density unevenness is corrected by associating in advance the reference signal with the position of the image at the timing when a test patch and the like are formed, or the like.

Meanwhile, it is preferable that the sizes of the photoreceptor drum 12 and the developing roll 19 according to the above-described exemplary embodiment be set to sizes at which the developing roll 19 is rotated natural number-time during one rotation of the photoreceptor drum 12, in consideration of the easiness at the time of correcting the density unevenness.

In addition, a process performed by the controller 56 of the image forming apparatus 10 according to the above-described exemplary embodiment may be stored as a program in a recording medium and distributed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A rotational position detection device comprising:
a position detection unit that is provided in a motor for driving a developing roll developing a latent image, detects a rotational position of the motor by using magnetism, and outputs a rotational position signal for each rotational position determined in advance; and
a generation unit that generates a reference signal indicating a reference position of rotation of the developing roll using the rotational position signal, based on a transmission ratio of a transmission mechanism that transmits driving of the motor to the developing roll.

2. The rotational position detection device according to claim 1, wherein
the transmission ratio is set to a value at which a number of rotations of the motor is natural number-time as large as a number of rotations of the developing roll.

3. The rotational position detection device according to claim 1, wherein
the transmission ratio is set to be a value at which a result of integration of a number of the rotational position signals output from the position detection unit during one rotation of the motor and a value obtained by dividing a number of rotations of the motor by a number of rotations of the developing roll is a natural number.

4. The rotational position detection device according to claim 1, wherein
the position detection unit detects magnetism of a rotating body of the motor, and
a number of magnetic poles of the motor is set to 2 and the transmission ratio is set to 1.

5. The rotational position detection device according to claim 1, wherein
the developing roll is set to have a size at which the developing roll is rotated natural number-time during one rotation of a photoreceptor drum on which a latent image is formed.

6. The rotational position detection device according to claim 2, wherein
the developing roll is set to have a size at which the developing roll is rotated natural number-time during one rotation of a photoreceptor drum on which a latent image is formed.

7. The rotational position detection device according to claim 3, wherein
the developing roll is set to have a size at which the developing roll is rotated natural number-time during one rotation of a photoreceptor drum on which a latent image is formed.

8. The rotational position detection device according to claim 4, wherein
the developing roll is set to have a size at which the developing roll is rotated natural number-time during one rotation of a photoreceptor drum on which a latent image is formed.

9. An image forming apparatus comprising:
a photoreceptor drum on which a latent image is formed;
an optical scanner that scans the photoreceptor drum with light based on image information to form the latent image;
a developing roll that develops the latent image formed on the photoreceptor drum;
a motor that drives the developing roll;
a transmission mechanism that transmits driving of the motor to the developing roll;
the rotational position detection device according to claim 1; and
a control unit that controls the optical scanner so as to correct an amount of light in scanning of the optical scanner, based on the reference signal generated by the generation unit of the rotational position detection device.

10. A non-transitory computer readable medium storing a rotational position detection program causing a computer to function as the generation unit of the rotational position detection device according to claim 1.
